(19) United States
(12) Patent Application Publication
(10) Pub. No.: US 2004/0239873 A1
(43) Pub. Date: Dec. 2, 2004

(54) Temple tip eyeglasses clasp

(76) Inventor: Dan L. Dietz, Houston, TX (US)

Correspondence Address: CONLEY ROSE, P.C., P. O. BOX 3267, HOUSTON, TX, 77253-3267, US

(21) Appl. No.: 10/447,079

(22) Filed: May 28, 2003

(51) Int. Cl. G02C 5/14

(52) U.S. Cl. 351/111

(57) ABSTRACT

An eyeglasses clasp for maintaining eyeglasses on a material. The clasp comprises magnets engaged with the eyeglasses temple tips that align with each other when the temple bars are closed. The magnets are thus in attractive magnetic communication through the material when the temple bars are closed. The clasp is used by pivoting one of the temple bars into the closed position. The frame body and closed temple bar are then positioned on one side of the material. The second temple bar is then pivoted into the closed position such that it is on the other side of the material. With the temple bars closed, the magnets are in attractive magnetic communication and impart a gripping force on the material.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to improved eyeglasses. More particularly, it relates to an eyeglasses clasp for maintaining the eyeglasses in a pocket or on a portion of a material when the eyeglasses are not in use.

2. Description of the Related Art

Typical eyeglasses consist of a frame body that houses two lenses on either side of a nose piece. Attached to the frame body are two temple bars that extend from two ends of the frame body. The temple bars pivot between an open position perpendicular with the frame body and a closed position parallel with the frame body. Sometimes attached to the temple bars are separate ear pieces, or temple tips. The temple bars and nose piece support the frame on the head of the wearer.

Individuals often remove their eyeglasses temporarily. They may put them down and not recall where, they may hang them around their neck where they bounce against their chest, or they may put them in a pocket and have them fall out and/or get damaged.

To solve this problem, the prior art teaches using mechanical clasps to clip eyeglasses to a garment worn by the user. These are cumbersome and, like all mechanical clasps, may come loose. Some mechanical clasps also depend on the availability of a shirt pocket, a cap visor, belt, holder, straps, or the like. In addition, clips may work well initially, but fatigue can cause metal clips to weaken and lose their ability to hold eyeglasses securely. Moreover, clips can break, thereby causing the eyeglasses to come loose, fall and break, or be lost. U.S. Pat. No. 6,017,120 to McCormick teaches a mechanical clip attached to the hinged end of the temple bars. Eyeglasses using such mechanical clips may not be securely held in place when inverted, such as when a person bends over at the waist. Another problem with such clips arises when a person in a sitting position bends forward, and the eyeglasses are pushed upward while clasped inside a shirt pocket. In that situation, the clip may be pushed up from the bottom of the pocket, thereby disengaging the clip and causing the eyeglasses to fall from the pocket.

The use of magnets on eyeglass frames for various purposes is also well known in the art. For example, a number of eyeglass frames have magnets that magnetize the wearer for health benefits. Other eyeglass frames use magnets to hold eyeglass frame sections together, thereby facilitating disassembly and reassembly in a new configuration, with auxiliary frames, lenses, or the like. U.S. Pat. No. 6,168,273 B11 to Dupraz et al. teaches the use of magnets on eyeglass frames to temporarily affix the eyeglasses on a support article having magnetic means. Because the magnets in Dupraz et al. are attached to the temple bar near the hinges, however, its teaching cannot be used as a magnetic clasp, nor was it intended as such.

### SUMMARY OF THE EMBODIMENTS

One embodiment of the eyeglasses clasp comprises magnets engaged with the temple tips on the temple bars of eyeglasses. The magnets engage the temple tips such that they align with each other when the temple bars are in the closed position. The magnets are thus in attractive magnetic communication at least when the temple bars are in the closed position.

The clasp is typically used by pivoting one of the temple bars into the closed position. The frame body and closed temple bar are then positioned on one side of a material. The material may be a clothing material, such as a shirt pocket or sleeve. The second temple bar is then pivoted into the closed position such that it is on the other side of the material. The magnets are then in attractive magnetic communication and impart a gripping force on the material. The gripping force is at least substantial enough to keep the glasses in place on the material during most normal activity.

The magnetic clasp thereby eliminates the disadvantages of a mechanical clip while introducing the advantage of a strong, versatile clasp that can be easily opened and closed anywhere the magnets are capable of being in strong enough attractive magnetic communication through the material.

In another embodiment of the eyeglasses, there is more than one magnet engaging each temple tip on the temple bars, with a corresponding number of magnets on the other temple tip.

The embodiments of the eyeglasses clasp may be in the form of complete eyeglasses, temple bars with magnets engaging the temple tips attached thereto, or a kit comprising magnets engaging the temple tips and a means of attaching the temple tips to the temple bars, with or without temple bars or other eyeglass components.

Thus, the embodiments comprise a combination of features and advantages that enable them to overcome various problems of prior devices. The various characteristics described above, as well as other features, will be readily apparent to those skilled in the art upon reading the following detailed description of the embodiments, and by referring to the accompanying drawings.

### BRIEF DESCRIPTION OF THE DRAWINGS

For a more detailed description of the embodiments, reference will now be made to the following accompanying drawings:

FIG. 1A is a bottom view of eyeglasses incorporating an eyeglasses clasp with temple bars pivoted in the open position as when the eyeglasses are worn;

FIG. 1B is a perspective view of the eyeglasses incorporating an eyeglasses clasp with one of the temple bars pivoted into the closed position,

FIG. 1C is a bottom view of the eyeglasses incorporating an eyeglasses clasp with the temple bars pivoted into the closed position;

FIG. 1C is a bottom view of the eyeglasses incorporating the eyeglasses clasp with the temple bars pivoted in the closed position depicting use of the clasp with clothing material;

FIG. 2A is a bottom view of another embodiment of the eyeglasses clasp;

FIG. 2B is a perspective view of the eyeglasses incorporating the eyeglasses clasp of FIG. 2A;

FIG. 3A is a bottom view of another embodiment of the eyeglasses clasp;

FIG. 3B is a perspective view of the eyeglasses incorporating the eyeglasses clasp of FIG. 3A;

FIG. 4 is a side view of another embodiment of the eyeglasses clasp; and

FIG. 5 is a side view of another embodiment of the eyeglasses clasp.

### DETAILED DESCRIPTION OF THE EMBODIMENTS

The present invention relates to an eyeglasses clasp and is susceptible to embodiments of different forms. The drawings and the description below disclose in detail specific embodiments of the present invention with the understanding that this disclosure is to be considered an exemplification of the principles of the invention, and is not intended to limit the invention to that illustrated and described in the disclosure. Further, it is to be fully recognized that the different teachings of the embodiments discussed below may be employed separately or in any suitable combination to produce desired results.

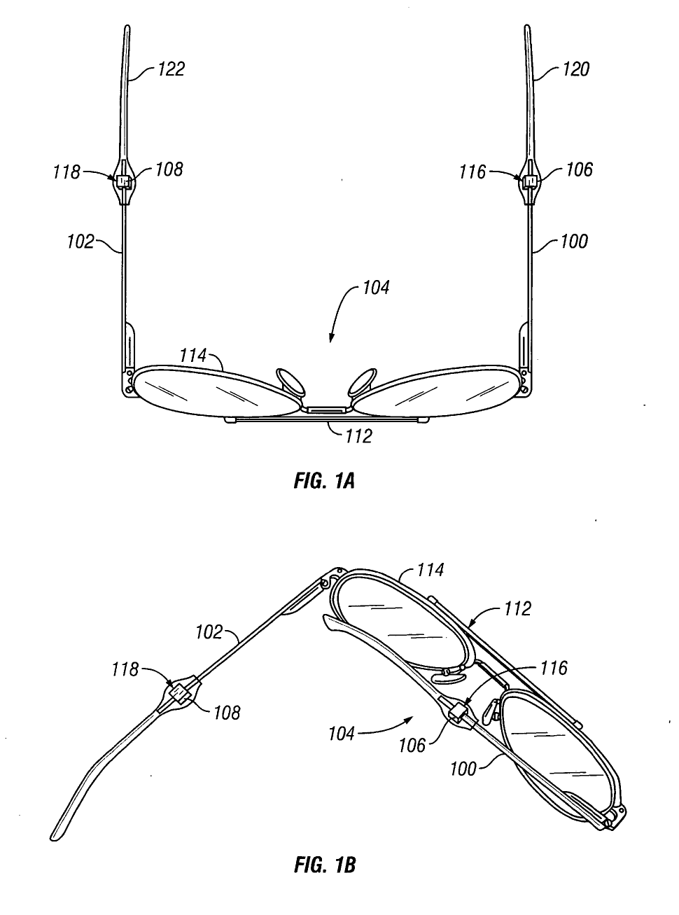

Referring initially to FIGS. 1A-1D, there is shown an embodiment of the eyeglasses clasp 104. A right temple bar 100 and a left temple bar 102 are pivotally attached to an eyeglasses frame body 114 by any suitable means. Typically, the temple bars 100, 102 are pivotally attached by spring action hinges well known in the art. The temple bars 100, 102 pivot between an open position shown in FIG. 1A and a closed position shown in FIG. 1C. In addition, the temple bar 100 comprises an earpiece, or temple tip 120 and the temple bar 102 comprises a temple tip 122. The frame body 114 also comprises a nose piece 112. A first magnet 106 engages the temple tip 120 and a second magnet 108 engages the temple tip 122 such that the polarity of the magnets 106, 108 directed outside the “U” shown in FIG. 1A is the same. The magnets 106, 108 engage the temple tips 120, 122 such that they align with each other when the temple bars 100, 102 are in the closed position. Thus, as illustrated in FIG. 1C, when temple bars 100, 102 are pivoted closed, the magnets 106, 108 are in attractive magnetic communication created by the opposite poles of the magnets 106, 108. FIG. 1C shows left temple bar 102 folded on the inside of right temple bar 100. The South pole side 116 of the magnet 106 thus faces and aligns with the North pole side 118 of the magnet 108, thereby holding the temple bars securely in the closed position.

The means for engaging the magnets 106, 108 to the temple tips 120, 122 may depend on the material from which the magnets 106, 108 and the temple tips 120, 122 are made. It should be appreciated that any suitable method may be used. Such attachment means for various temple materials may include grooved means, adhesive means, shrink-wrap tubing, hinged clips, metal clamps, threaded hardware, and the like, and/or a combination thereof.

The magnets 106, 108 may also be injection molded into the temple tips 120, 122. As shown in FIGS. 1A-1C, the magnets 106, 108 may have a hollow space extending therethrough to allow passage of the temple bars 100, 102. In addition, the magnets 106, 108 may be protected from corrosion by a number of means, including by way of non-limiting example, coatings of zinc, nickel, copper, gold, different colored epoxy, aluminum chromate, and/or different types of paint.

Referring now to FIG. 1D, the left temple bar 100 and the right temple bar 102 of the eyeglasses clasp 104 are pivoted into the closed position. The left temple bar 100 is positioned outside a material 110. The right temple bar 102 is positioned on one side the material 110. Thus, the material 110 is located between the temple bars 100, 102. During use, the wearer pivots one of the temple bars 100, 102 into the closed position. The wearer then positions the eyeglasses frame body 114 and the closed temple bar on one side of the material 110. The wearer then pivots the other temple bar into the closed position such that it is on the other side of the material 110. The magnet 106 aligns with the magnet 108. Although on either side of the material 110, the magnets 106, 108 are in attractive magnetic communication with each other. The attractive magnetic communication is strong enough to impart a gripping force on the material 110, thereby holding the eyeglasses 114 securely clasped to the material 110. The gripping force is at least substantial enough to keep the eyeglasses 114 in place on the material 110 during most normal activity. The magnets 106, 108 are also able to maintain this strength because the magnetic flux is not diminished by repeated use. It should be appreciated that either temple bar 100 or 102 may be pivoted into the closed position before the other and still be within the scope of the invention.

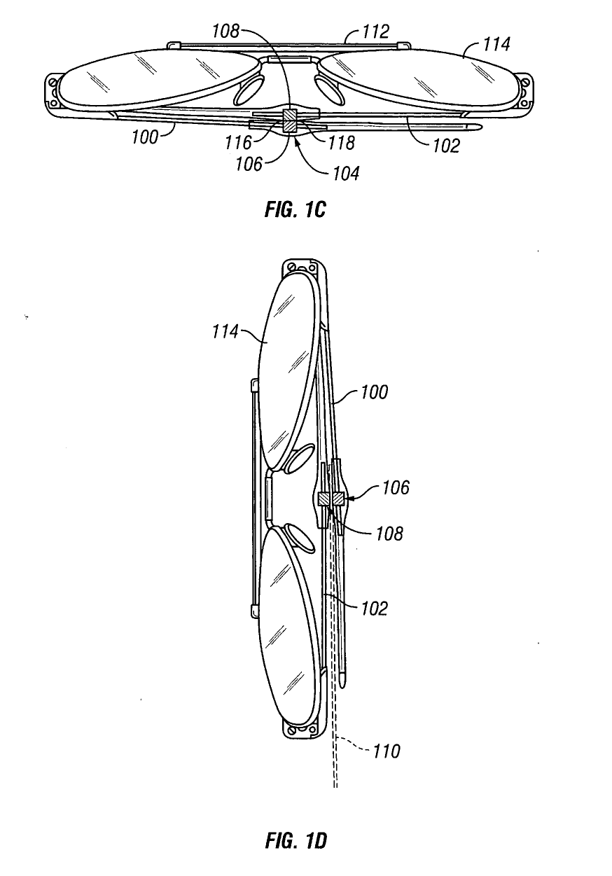

Referring now to FIGS. 2A and 2B, there is shown an embodiment of an eyeglasses clasp 204. The clasp 204 includes a right temple bar 200 and a left temple bar 202 pivotally attached to an eyeglasses frame body 214 by any suitable means. Typically, the temple bars 202, 203 are pivotally attached by spring action hinges well known in the art. The temple bars 200, 202 pivot between an open position and a closed position similarly to temple bars 100, 102 discussed above. In addition, the temple bar 200 comprises a temple tip 220 and the temple bar 202 comprises a temple tip 222. The frame body 214 also comprises a nose piece 212. A first magnet 206 engages the temple tip 220 and a second magnet 208 engages the temple tip 222 such that the polarity of the magnets 206, 208 directed outside the “U ” shown in FIG. 2A is the same. The magnets 206, 208 align with each other when the temple bars 200, 202 are in the closed position. Similarly, a third magnet 207 engages the temple tip 220 and a fourth magnet 209 engages the temple tip 222 such that the polarity of the third and fourth magnets 207, 209 directed outside the “U” shown in FIG. 2A is the same. The third and fourth magnets 207, 209 align with each other when the temple bars 200, 202 are in the closed position. Thus, when the temple bars 200, 202 are pivoted closed, the magnets 206, 208 are in attractive magnetic communication created by the opposite poles of the magnets 206, 208, thereby holding the temple bars 200, 202 securely in the closed position. Similarly, when the temple bars 200, 202 are pivoted closed, the magnets 207, 209 are in attractive magnetic communication created by the opposite poles of the magnets 207, 209, thereby also holding the temple bars 200, 202 securely in the closed position.

The means for engaging the magnets 206, 207, 208, and 209 to the temple tips 220, 222 may depend on the material from which the magnets 206, 207, 208, and 209 and the temple tips 220, 222 are made. It should be appreciated that any suitable method may be used. Such attachment means for various temple materials may include grooved means, adhesive means, shrink-wrap tubing, hinged clips, metal clamps, threaded hardware, and the like, and/or a combination thereof. The magnets 206, 207, 208, and 209 may also be injection molded into the temple tips 220, 222. As shown in FIGS. 2A-2B, the magnets 206, 207, 208, and 209 may have a hollow space extending therethrough to allow passage of the temple bars 200, 202. In addition, the magnets 206, 207, 208, and 209 may be protected from corrosion by a number of means, including coatings of zinc, nickel, copper, gold, different colored epoxy, aluminum chromate, and/or different types of paint.

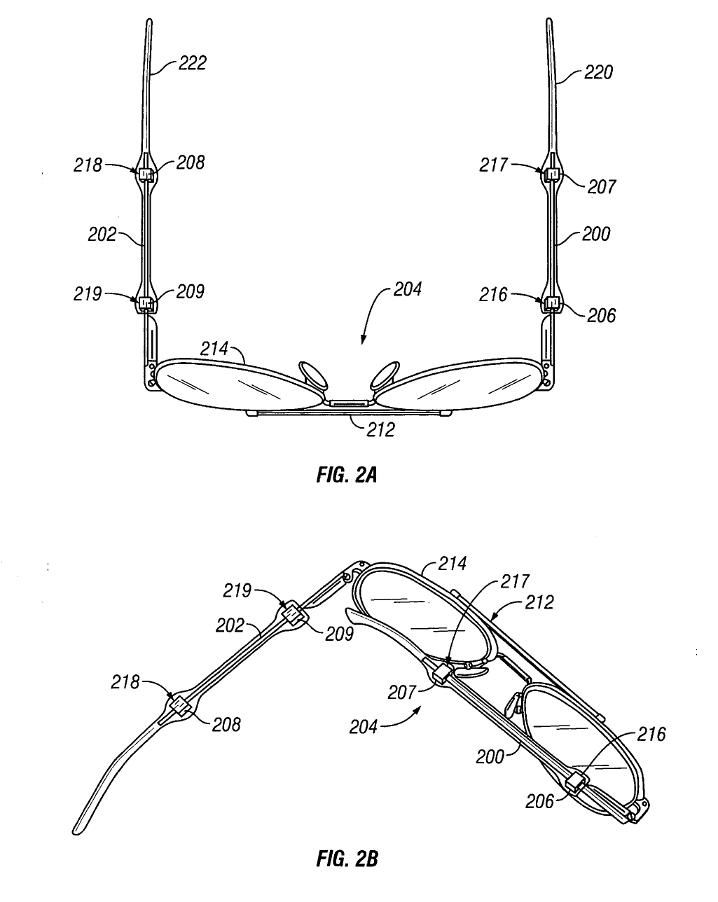

Referring to FIGS. 3A and 3B, there is shown an embodiment of the eyeglasses clasp 304. A right temple bar 300 and a left temple bar 302 are pivotally attached to an eyeglasses frame body 314 by any suitable means. Typically, the temple bars 300, 302 are pivotally attached by spring action hinges well known in the art. The temple bars 300, 302 pivot between an open position and a closed position similarly to the temple bars 100, 102 discussed above. In addition, the temple bar 300 comprises a temple tip 320 and the temple bar 302 comprises a temple tip 322. The frame body 314 also comprises a nose piece 312. A first magnet 306 engages the temple tip 320 and a second magnet 308 engages the temple tip 322. The clasp 304 operates in a similar manner as the eyeglasses clap 104 except, as shown in FIGS. 3A and 3B, the magnets 306, 308 engaged the exterior of the temple tips 300, 302. There may also be more than one magnet engaging each temple tip as discussed above.

The means for engaging the magnets 306, 308 to the temple tips 320, 322 may depend on the material from which the magnets 306, 308 and the temple tips 320, 322 are made. It should be appreciated that any suitable method may be used. Such attachment means for various temple materials may include grooved means, adhesive means, shrink-wrap tubing, hinged clips, metal clamps, threaded hardware, and the like, and/or a combination thereof. As shown in FIGS. 3A and 3B, the magnets 306, 308 may have a hollow space extending therethrough to allow passage of the temple bars 300, 302. In addition, the magnets 306, 308 may be protected from corrosion by a number of means, including by way of non-limiting example, coatings of zinc, nickel, copper, gold, different colored epoxy, aluminum chromate, and/or different types of paint.

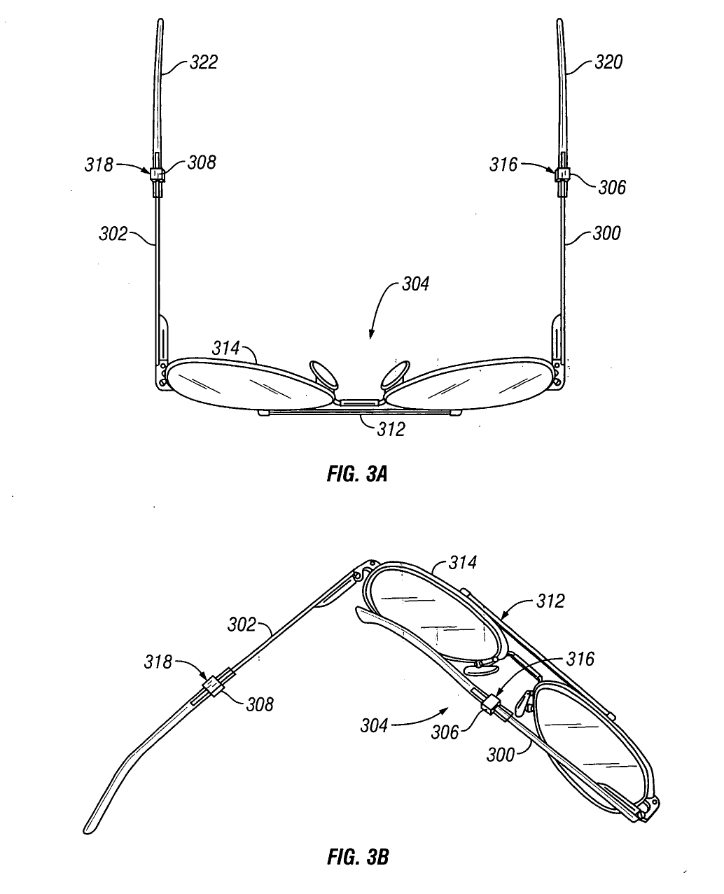

Referring now to FIG. 4, another embodiment of the eyeglasses clasp 404 is shown. As shown in FIG. 4, the eyeglasses clasp 404 is in “kit” form and only comprises temple bars 400, 402 and temple tips 420, 422 comprising magnets 406, 408, respectively. The temple bars 400, 402 may be attached to any suitable eyeglasses frame such that the eyeglasses clasp 404 operates in a similar manner as the eyeglasses clasp 104 discussed above. The eyeglasses clasp 404 may also be configured in a similar manner as eyeglasses clasps 204 and 304 discussed above.

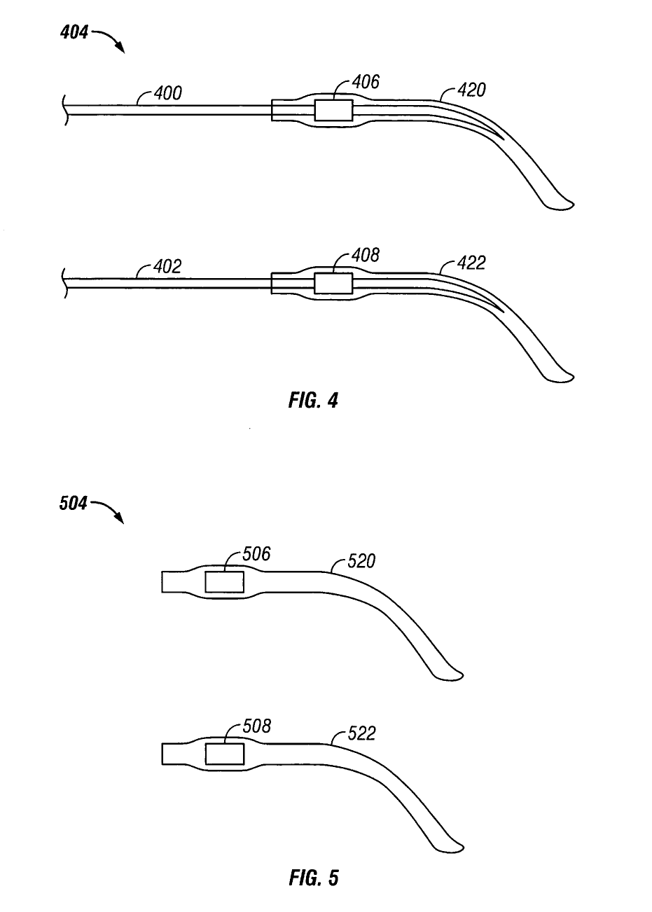

Referring now to FIG. 5, another embodiment of the eyeglasses clasp 504 is shown. As shown in FIG. 5, the eyeglasses clasp 404 is in “kit” form and only comprises temple tips 520, 522 comprising magnets 506, 508, respectively. The temple tips 520, 522 may be attached to any suitable eyeglasses frame temple bars such that the eyeglasses clasp 504 operates in a similar manner as the eyeglasses clasp 104 discussed above. The eyeglasses clasp 504 may also be configured in a similar manner as eyeglasses clasps 204 and 304 discussed above.

The present invention eliminates difficulties associated with using a support article by, in effect, using the eyeglasses themselves as a means for clasping onto any material through which the magnets may remain in attractive magnetic communication. For example, a separate support article incorporated in clothing would be cumbersome in washers and dryers, difficult to iron, and alter the appearance of the garment whereas the present invention has none of these disadvantages. In addition, unlike mechanical clips that attach to clothing described in the prior art, the present invention is not limited by the requirement that such clips attach to the edge of material. Instead, the clasp of the present invention attaches anywhere through material so that only a hinged edge of the frame body is at the edge of the material. Thus, for example, the present invention permits eyeglasses to be clasped more deeply in a pocket, whereas prior art clips require a greater portion of the eyeglasses to protrude outside the pocket. Moreover, the eyeglasses stay attached regardless of the position in which the clothing material edge is placed.

While specific embodiments have been shown and described, modifications can be made by one skilled in the art without departing from the spirit or teaching of this invention. The embodiments as described are exemplary only and are not limiting. Many variations and modifications of the system and apparatus are possible and are within the scope of the invention. Accordingly, the scope of protection is not limited to the embodiments described, but is only limited by the claims that follow, the scope of which shall include all equivalents of the subject matter of the claims.

1. Eyeglasses comprising:
a frame body, a first temple bar pivotally engaged to a first end of the frame body and comprising a first temple tip, and a second temple bar pivotally engaged to a second end of the frame body and comprising a second temple tip;
a first magnet engaged with the first temple tip;
a second magnet engaged with the second temple tip;
the first and second magnets being in attractive magnetic communication when the temple bars are in a closed position but separated by clothing material, the attractive magnetic communication imparting a gripping force on the clothing material.

2. The eyeglasses in claim 1 wherein there is more than one magnet engaged with the temple tips.

3. The eyeglasses of claim 1 wherein the magnets are inside the temple lips.

4. The eyeglasses of claim 1 wherein the magnets engage the exterior of the temple tips.

5. The eyeglasses in claim 1 wherein the magnets engage the temple tips with an adhesive.

6. The eyeglasses in claim 1 wherein the magnets are MGO grade 35 Neodymium.

7. The eyeglasses in claim 1 wherein the magnets are covered with a coating to prevent rust.

8. The eyeglasses in claim 1 wherein the magnets include a hollow passage extending therethrough.

9. A clasp for eyeglasses comprising a frame comprising:
a first temple bar engageable with the eyeglasses and comprising a first temple tip, the first temple tip comprising a first magnet;
a second temple bar engageable with the eyeglasses and comprising a second temple tip the second temple tip comprising a second magnet;
the first and second magnets being in attractive magnetic communication when the temple bars are engaged with the eyeglasses in a closed position but separated by clothing material, the attractive magnetic communication imparting a gripping force on the clothing material.

10. The eyeglasses in claim 9 wherein there is more than one magnet engaged with the temple tips.

11. The eyeglasses of claim 9 wherein the magnets are inside the temple tips.

12. The eyeglasses of claim 9 wherein the magnets engage the exterior of the temple tips.

13. The eyeglasses in claim 9 wherein the magnets engage the temple tips with an adhesive.

14. The eyeglasses in claim 9 wherein the magnets are MGO grade 35 Neodymium.

15. The eyeglasses in claim 9 wherein the magnets are covered with a coating to prevent rust.

16. The eyeglasses in claim 9 wherein the magnets include a hollow passage extending therethrough.

17. A clasp for eyeglasses comprising a first temple bar and a second temple bar, the clasp comprising:
a first magnet engaged with a first temple tip, the first temple tip engageable with the first eyeglasses temple bar;
a second magnet engaged with a second temple tip, the second temple tip engageable with the second eyeglasses temple bar;
the first and second magnets being in attractive magnetic communication when the temple tips are engaged with the eyeglasses temple bars in a closed position but separated by clothing material, the attractive magnetic communication imparting a gripping force on the clothing material.

18. The eyeglasses in claim 17 wherein there is more than one magnet engaged with the temple tips.

19. The eyeglasses of claim 17 wherein the magnets are inside the temple tips.

20. The eyeglasses of claim 17 wherein the magnets engage the exterior of the temple tips.

21. The eyeglasses in claim 17 wherein the magnets engage the temple tips with all adhesive.

22. The eyeglasses in claim 17 wherein the magnets are MGO grade 35 Neodymium.

23. The eyeglasses in claim 17 wherein the magnets are covered with a coating to prevent rust.

24. The eyeglasses in claim 17 wherein the magnets include a hollow passage extending therethtough.

25. A method of clasping a clothing material with eyeglasses comprising:
imparting a gripping force on the clothing material by placing a first magnet engaging a first eyeglasses temple tip and a second magnet engaging a second eyeglasses temple tip in attractive magnetic communication with each other through the clothing material.
